(19) United States
(12) Patent Application Publication
(10) Pub. No.: US 2026/0119264 A1
(43) Pub. Date: Apr. 30, 2026

(54) DYNAMIC DISTRIBUTION OF COMPRESSION AND DECOMPRESSION JOB REQUESTS TO HARDWARE ACCELERATORS

(71) Applicant: NetApp, Inc., San Jose, CA (US)

(72) Inventors: Venkateswarlu Tella, Bangalore (IN); Divya Balasubramaniam, Bengaluru (IN); Viral Bharat Shah, Vadodara (IN); Vennila Sivakumar, Chennai (IN)

(73) Assignee: NetApp, Inc., San Jose, CA (US)

(21) Appl. No.: 18/926,667

(22) Filed: Oct. 25, 2024

(51) Int. Cl. G06F 9/50

(52) U.S. Cl. CPC G06F 9/505; G06F 9/5044

(57) ABSTRACT

Dynamic distribution of compression and decompression job requests to hardware accelerators is disclosed. A set of requests is evaluated to determine a number of compression jobs and a number of decompression jobs in the set of requests. A first set of hardware accelerator engines is allocated to perform compression jobs, and a second set of hardware accelerator engines is allocated to perform decompression jobs. Compression jobs are assigned to the first set of hardware accelerator engines based, at least in part, on a compressibility score of the corresponding job and a workload of the selected hardware accelerator engine. Decompression jobs are assigned to the second set of hardware accelerator engines based, at least in part, on a decompression weight of the corresponding job and a workload of the selected hardware accelerator engine.

### BACKGROUND

Hardware accelerators are purpose-built designs that accompany a processor for accelerating a specific function or workload. Hardware accelerators have multiple engines which can perform compute-intensive tasks like compression and decompression. For effective utilization of these engines, distribution of the compression and decompression requests is of importance as there are multiple threads from which various typ42,879es of requests can be sent to these engines.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a block diagram of an example architecture to dynamically distribute compression and decompression job requests to hardware accelerators.

FIG. 2 is a flow diagram of an example approach to dynamically distribute compression and decompression job requests to hardware accelerators.

FIG. 3 is a flow diagram of an example approach corresponding to a partial expansion of the approach illustrated in FIG. 2 to dynamically distribute compression and decompression job requests to hardware accelerators.

FIG. 4 is a flow diagram of an example approach to dynamically distribute compression job requests to hardware accelerators.

FIG. 5 is a flow diagram of an example approach to dynamically distribute decompression job requests to hardware accelerators.

FIG. 6 is a block diagram of an example system to dynamically distribute compression and decompression job requests to hardware accelerators.

FIG. 7 is a block diagram of an example system to dynamically distribute compression and decompression job requests to hardware accelerators.

FIG. 8 is a block diagram of an example system to dynamically distribute compression and decompression job requests to hardware accelerators.

FIG. 9 is a block diagram of an example system to dynamically distribute compression and decompression job requests to hardware accelerators.

FIG. 10 illustrates one embodiment of a block diagram of a node.

### DETAILED DESCRIPTION

In the following description, for the purposes of explanation, numerous specific details are set forth in order to provide a thorough understanding of the present disclosure. It will be apparent, however, to one skilled in the art that the present disclosure may be practiced without some of these specific details. In other instances, well-known structures and devices are shown in block diagram form to avoid obscuring the underlying principles of the present disclosure.

In view of the shortcomings described above, there is a need for a method for smart load balancing of all the requests across the available engines and providing better throughput to increase efficiency. The present disclosure provides approaches for dynamic distribution of job requests for effective utilization of offload devices that can overcome these shortcomings. Accordingly, the present disclosure provides various approaches for distributing the incoming requests to the available engines based on a smart distribution strategy, causing the accelerator to perform the smart distribution of workload.

The approaches described below capable of distributing the available endpoints (i.e., hardware acceleration devices or engines) based on the incoming compression and decompression request, which can dynamically change every learning phase (e.g., 5 minutes, 3 minutes). Within the learning phase interval, a scoring of the request types is used to decide the number of endpoints for compression and decompression requests and the endpoint is selected (e.g., randomly, round robin) from each of these.

In an example, for each of the endpoints, there is a logical structure that is used to submit requests to an endpoint. A lock is taken if multiple threads are trying to submit requests to the same endpoint, due to which the lock contention can occur if there is only one instance per endpoint. In an example, the approaches described reduce the lock contention by associating each processor to a particular instance number. This ensures that, whenever a request comes in, only the endpoint selection would be random as described previously. These approaches provide improved throughput, reduced latency and provide efficient utilization of hardware resources.

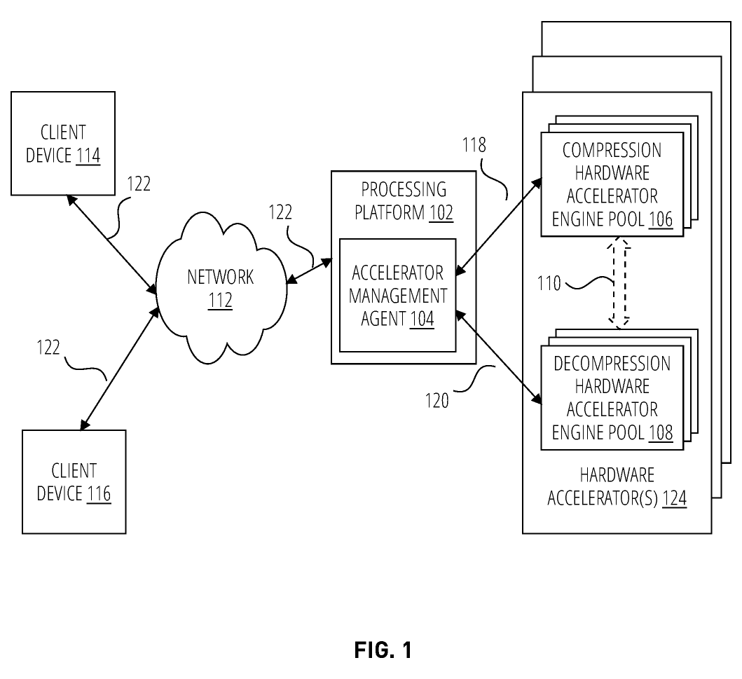

FIG. 1 is a block diagram of an example architecture to dynamically distribute compression and decompression job requests to hardware accelerators. The throughput of hardware accelerators is known to drop if the hardware accelerator receives a mix of compression and decompression requests. Hence, it is beneficial for the available engines to be dedicated to handle either compression or decompression requests. Techniques for evaluation and allocation of dedicated compression and decompression engines are provided below.

In the example architecture of FIG. 1, processing platform 102 is coupled with network 112 to receive compression/decompression requests 122. compression/decompression requests 122 can include any type of compression/decompression requests that can be serviced by processing platform 102. Thus, some of compression/decompression requests 122 can involve compression operations and/or decompression operations. compression/decompression requests 122 originate from remote client devices (e.g., client device 114, client device 116) coupled to processing platform 102 via network 112. Any number of client devices can be supported.

In an example, processing platform 102 includes accelerator management agent 104 to provide some or all of the functionality associated with dynamically distributing compression and decompression job requests to hardware accelerators. As described in greater detail below, accelerator management agent 104 can organize compression hardware accelerator engine pool 106 and decompression hardware accelerator engine pool 108 based on various approaches described below. The various hardware engines are assigned to a pool for a period of time and, at the end of that period of time, can be moved to the other pool (as illustrated by dashed arrow 110). Any number of hardware accelerators (e.g., hardware accelerator(s) 124) and any number of corresponding hardware accelerator engines can be utilized via the approaches described herein. After separating the accelerator engines into compression and decompression pools, jobs can be sent (e.g., compression jobs 118, decompression jobs 120).

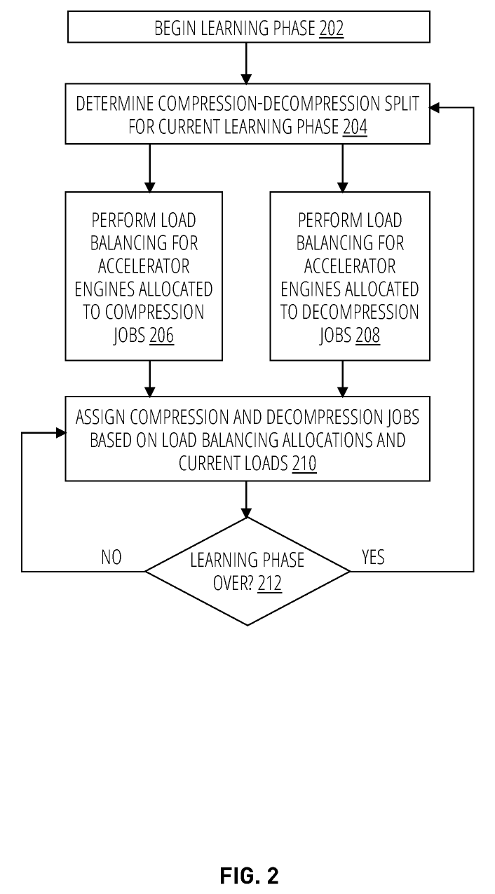

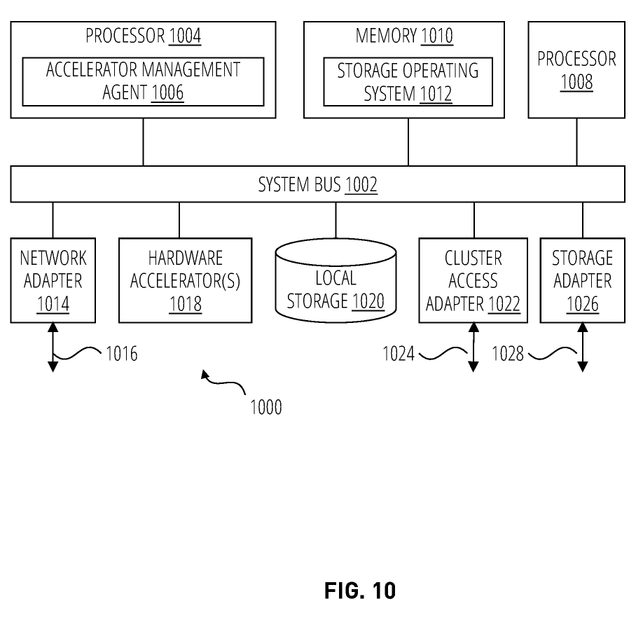

FIG. 2 is a flow diagram of an example approach to dynamically distribute compression and decompression job requests to hardware accelerators. The example flow diagram of FIG. 2 illustrates the higher-level operations that can be performed by an accelerator management agent (e.g., accelerator management agent 104 in FIG. 1) or another computing device. In another example, the functionality can be provided by a storage operating system (e.g., storage operating system 1012 in FIG. 10).

Illustratively, storage operating system 1012 can be the Data ONTAP® operating system available from NetApp™, Inc., Sunnyvale, Calif. that implements a Write Anywhere File Layout (WAFL®) file system. However, it is expressly contemplated that any appropriate storage operating system may be enhanced for use in accordance with the inventive principles described herein. As such, where the term “WAFL” is employed, it should be taken broadly to refer to any storage operating system that is otherwise adaptable to the teachings of this disclosure. In an example, the ONTAP operating system can provide dynamic distribution of compression job requests and decompression job requests to a pool of hardware accelerators.

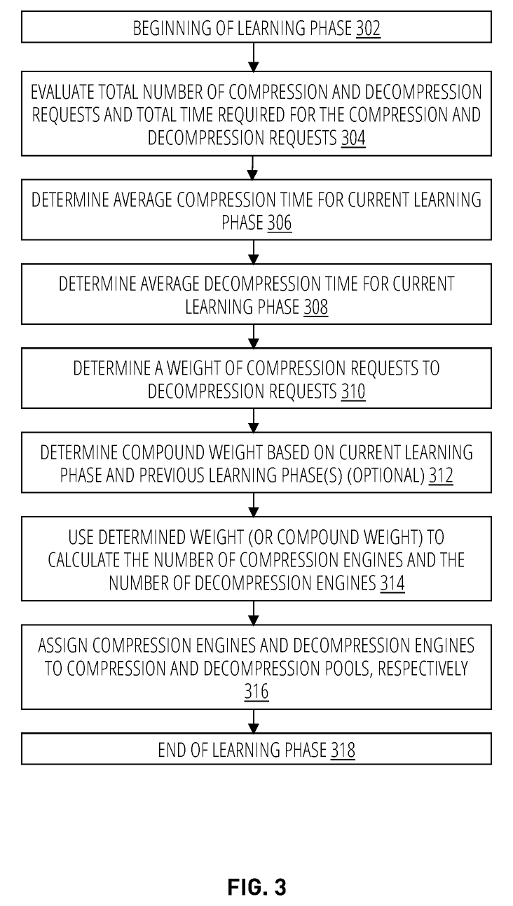

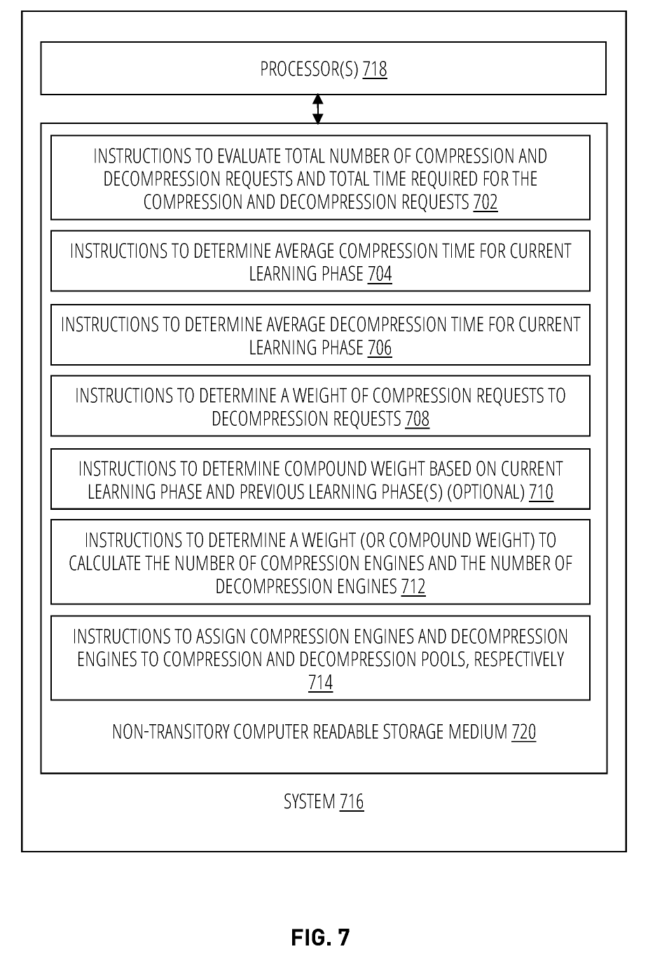

In an example, the operations described are performed within a specified time window referred to herein as a “learning phase;” however, other labels can be used to refer to this time window. The learning phase can be any appropriate period of time (e.g., 5 minutes, 10 minutes, 90 seconds, 3 minutes). In an example, the learning phase starts, 202, and an example approach to determining a compression-decompression split can be initiated, 204. The compression-decompression split refers to allocation of hardware accelerator engines to compression pools (e.g., compression hardware accelerator engine pool 106) and to decompression pools (e.g., decompression hardware accelerator engine pool 108). Example approaches for determining the compression-decompression split are provided in FIG. 3 and FIG. 7.

After the determination of the compression pool and decompression pool, load balancing analysis is performed on both compression jobs and decompression jobs. In the example of FIG. 2, the load balancing analysis is illustrated as being performed in parallel. Alternatively, the load balancing operations can be performed sequentially. In an example, the analysis and approach utilized for compression jobs is different than the analysis and approach utilized for decompression jobs.

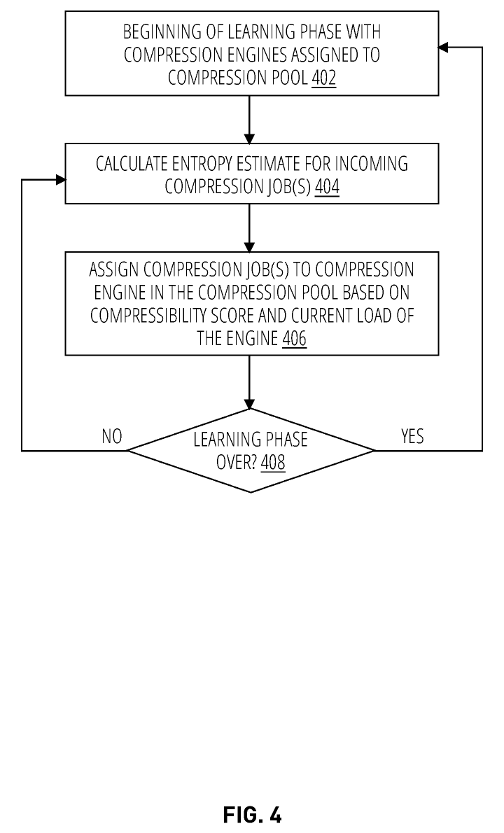

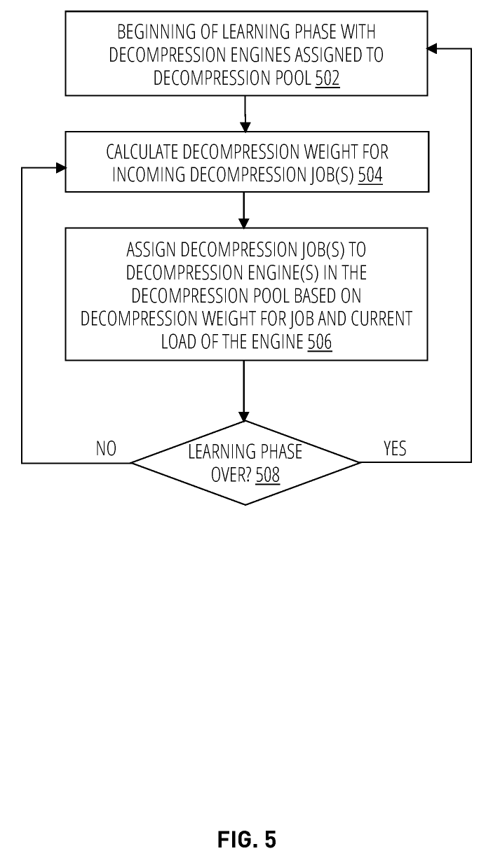

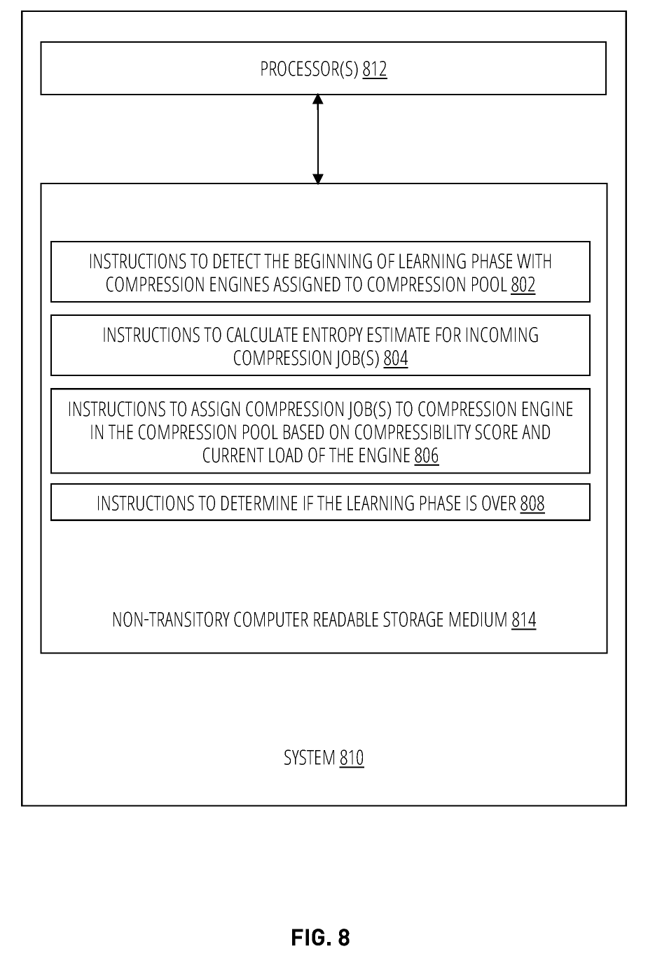

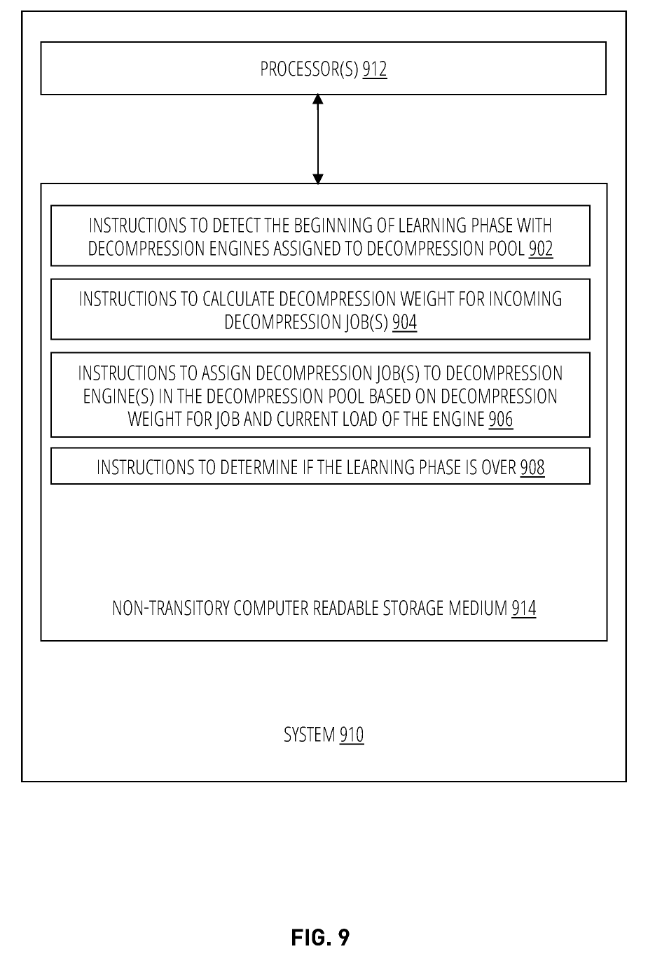

Compression jobs and decompression jobs are assigned to hardware accelerator engines based on the current load of the engine and the analysis performed on the specific job to be assigned, 210. An example of analysis and assignment for compression jobs in provided in FIG. 4 and FIG. 8. An example of analysis and assignment for decompression jobs is provided in FIG. 5 and FIG. 9. The assignment approach as described continues for the current learning phase.

Thus, if the learning phase is not over, 212, then compression jobs and decompression jobs are assigned to hardware accelerator engines as described, 210. If the learning phase is over, 212, the flow repeats (e.g., returning to 204) for the new learning phase.

FIG. 3 is a flow diagram of an example approach corresponding to a partial expansion of the approach illustrated in FIG. 2 to dynamically distribute compression and decompression job requests to hardware accelerators. The example flow of FIG. 3 is directed to the allocation of accelerator engines to the compression job pool and to the decompression job pool during a learning phase. The example flow of FIG. 3 corresponds approximately to 204 in FIG. 2. The flow described in FIG. 3 can be repeated for each subsequent learning phase.

In response to the beginning of a learning phase, 302, the total number of compression requests and decompression requests and the total time required for the compression requests and for the decompression requests are evaluated, 304. In an example, the average compression time is determined by the total compression time in the learning phase divided by the number of compression requests in the learning phase. Other formulas or approximations can also be used.

The average decompression time for the learning phase is also determined, 308. In an example, the average decompression time is determined by the total decompression time in the learning phase divided by the number of decompression requests in the learning phase. Other formulas or approximations can also be used.

Generally, the cost of compression is higher than the cost of decompression and hence, the compression and decompression requests are assigned a weight, 310, so that the requests get dedicated endpoints based on the respective execution time. In an example, the weight is determined based on the average compression time for the learning phase divided by the average decompression time for the learning phase. Other formulas or approximations can also be used. In an optional example, the information from a previous learning phase may be applied in the current learning phase, 312. The computed ratio has shown to adjust itself within two iterations of learning, even if the workload changes are drastic.

The weight (or compound weight) is used to calculate the number of compression engines and the number of decompression engines for the learning phase, 314. Specific hardware accelerator engines are assigned as compression engines or decompression engines based on the determination, 316. Execution of compression and decompression jobs is performed using the allocated accelerator engines for the current learning phase. At the end of the current learning phase, 318, the process can be repeated. If not using compound weight calculations, the calculations from the current learning phase are reset for the subsequent learning phase.

FIG. 4 is a flow diagram of an example approach to dynamically distribute compression job requests to hardware accelerators. The example flow of FIG. 4 is directed to management of compression jobs during a learning phase. The flow of FIG. 4 assumes that the allocation of hardware accelerator engines to the compression pool and the decompression pool has been completed (e.g., 204 in FIG. 2 has been completed).

The data sent in the incoming requests may have varying compressibility, as they can have a mix of compressible and incompressible data. Hence, these requests need to be distributed across the number of engines allocated for handling the compression requests as discussed above, 402.

An entropy estimate is calculated for each incoming compression job, 404. A compressibility score is assigned based on an entropy estimate that is calculated according to the compressibility of the data. An example entropy estimation technique is “Chi Square;” however, other techniques can also be used. Here, a lower data entropy value is indicative of higher compressibility and lower compression cost. Whereas a higher data entropy value indicates lower compressibility and higher compression cost. In an example, the entropy values are scaled on a range of 1 to 10 and assigned as the compressibility score of the incoming compression request. Other scaling and scoring strategies can also be used, for example, to achieve finer granularity.

In an example, each of the compression engines will have a tracking mechanism that indicates the current load on it. In an example, the current load of an engine is the sum of compressibility scores of all the compression requests that are enqueued and being processed by that engine. For an incoming compression request, an engine is assigned by analyzing the current loads on all the engines and selecting the engine with the lowest load, 406.

The process continues until the current learning phase is over, 408. For the subsequent learning phase, a similar flow occurs with the updated number of allocated compression engines.

FIG. 5 is a flow diagram of an example approach to dynamically distribute decompression job requests to hardware accelerators. The example flow of FIG. 5 is directed to management of decompression jobs during a learning phase. The flow of FIG. 5 assumes that the allocation of hardware accelerator engines to the compression pool and the decompression pool has been completed (e.g., 204 in FIG. 2 has been completed).

In general, the management and allocation of decompression jobs is handled differently than the management and allocation of compression jobs because, for compression jobs, a compressibility analysis (e.g., entropy calculation) is used to estimate how compressible the job is and the corresponding cost in terms of hardware accelerator resources. However, for decompression the data has already been compressed and the original entropy calculation information is not available.

In an example, a decompression weight is determined for incoming decompression jobs, 504. In an example, the input length, which represents the compressed data length, of the decompression request is used to compute a decompression weight for each incoming decompression request. The compressed data may have varying times for various compressed data and normally follow a concave down graph structure (decompression times for 1 blk → 8 blk and 7 blk → 8blk are mostly in the same range, as is for 2 blk → 8 blk and 6 blk → 8 blk and so on). In an example a range of 1 to 4 is used for the decompression weight. Other scales (e.g., 1 to 2, 1 to 8) can be used to provide different granularity.

In an example, each of the decompression engines has a tracking mechanism that indicates the current load on it. In an example, the current load of an engine is the sum of weights of all the decompression requests that are enqueued and still being processed by that engine. For an incoming decompression request, an engine is assigned by evaluating the current loads on all the engines and picking and selecting one with the lowest current load, 506.

The process continues until the current learning phase is over, 508. For the subsequent learning phase, a similar flow occurs with the updated number of allocated decompression engines.

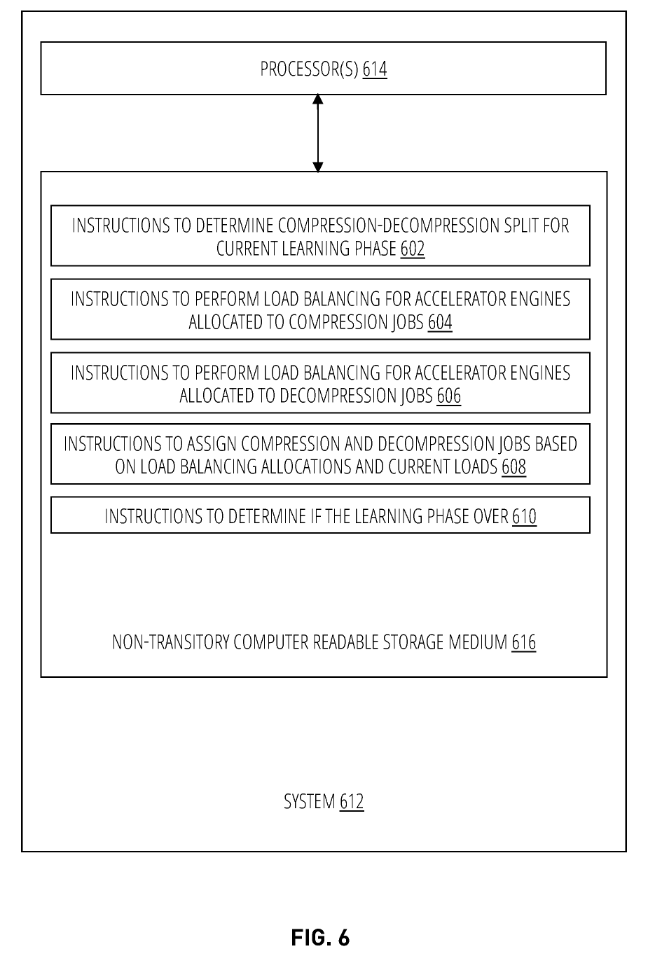

FIG. 6 is a block diagram of an example system to dynamically distribute compression and decompression job requests to hardware accelerators. In an example, system 612 can include processor(s) 614 and non-transitory computer readable storage medium 616. In an example, processor(s) 614 and non-transitory computer readable storage medium 616 can be part of a management node having a storage operating system that can provide some or all of the functionality of the ONTAP software.

Non-transitory computer readable storage medium 616 may store instructions 602, 604, 606, 608 and 610 that, when executed by processor(s) 614, cause processor(s) 614 to perform various functions. Examples of processor(s) 614 may include a microcontroller, a microcontroller, a microprocessor, a central processing unit (CPU), a graphics processing unit (GPU), a data processing unit (DPU), an application-specific integrated circuit (ASIC), a field programmable gate array (FPGA), a system on a chip (SoC), etc. Examples of non-transitory computer readable storage medium 616 include tangible media such as random-access memory (RAM), read-only memory (ROM), electrically erasable programmable read-only memory (EEPROM), flash memory, a hard disk drive, etc.

In an example, the operations described are performed within a specified time window referred to herein as a “learning phase;” however, other labels can be used to refer to this time window. The learning phase can be any appropriate period of time (e.g., 5 minutes, 10 minutes, 90 seconds, 3 minutes).

Instructions 602 cause processor(s) 614 to determine a compression-decompression split. The compression-decompression split refers to allocation of hardware accelerator engines to compression pools (e.g., compression hardware accelerator engine pool 106) and to decompression pools (e.g., decompression hardware accelerator engine pool 108). Example approaches for determining the compression-decompression split are provided in FIG. 3 and FIG. 7.

Instructions 604 cause processor(s) 614 to perform load balancing for accelerator engines allocated to compression jobs. Example approaches for managing compression jobs are provided in FIG. 4 and FIG. 8.

Instructions 606 cause processor(s) 614 to perform load balancing for accelerator engines allocated to decompression jobs. Example approaches for managing compression jobs are provided in FIG. 5 and FIG. 9.

Instructions 608 cause processor(s) 614 to assign compression and decompression jobs based on load balancing allocations and current loads. Example approaches for evaluating compression jobs and assigning the compression jobs to available hardware accelerator engines are provided in FIG. 4 and FIG. 8. Example approaches for evaluating decompression jobs and assigning the decompression jobs to available hardware accelerator engines are provided in FIG. 5 and FIG. 9.

Instructions 610 cause processor(s) 614 to determine if the current learning phase is over. If the current learning phase is not over, then compression jobs and decompression jobs are assigned to hardware accelerator engines as described. If the learning phase is over, then the operations repeat for the new learning phase.

FIG. 7 is a block diagram of an example system to dynamically distribute compression and decompression job requests to hardware accelerators. In an example, system 716 can include processor(s) 718 and non-transitory computer readable storage medium 720. In an example, processor(s) 718 and non-transitory computer readable storage medium 720 can be part of a management node having a storage operating system that can provide some or all of the functionality of the ONTAP software as mentioned above.

Non-transitory computer readable storage medium 720 may store instructions 702, 704, 706, 708, 710, 712 and 714 that, when executed by processor(s) 718, cause processor(s) 718 to perform various functions. Examples of processor(s) 718 may include a microcontroller, a microcontroller, a microprocessor, a CPU, a GPU, a DPU, an ASIC, a FPGA, a SoC, etc. Examples of non-transitory computer readable storage medium 720 include tangible media such as RAM, ROM, EEPROM, flash memory, a hard disk drive, etc.

Instructions 702 cause processor(s) 718 to evaluate the total number of compression and decompression requests and the total time required for the compression and decompression requests. In an example, the average compression time is determined by the total compression time in the learning phase divided by the number of compression requests in the learning phase. Other formulas or approximations can also be used.

Instructions 704 cause processor(s) 718 to determine the average compression time for the learning phase. In an example, the average compression time is determined by the total compression time in the learning phase divided by the number of compression requests in the learning phase. Other formulas or approximations can also be used.

Instructions 706 cause processor(s) 718 to determine the average decompression time for the learning phase. In an example, the average decompression time is determined by the total decompression time in the learning phase divided by the number of decompression requests in the learning phase. Other formulas or approximations can also be used.

Instructions 708 cause processor(s) 718 to determine a weight of compression requests to decompression requests. As discussed above, the cost of compression is higher than the cost of decompression and hence, the compression and decompression requests are assigned a weight, so that the requests get dedicated endpoints based on the respective execution time. In an example, the weight is determined based on the average compression time for the learning phase divided by the average decompression time for the learning phase. Other formulas or approximations can also be used.

Instructions 710 cause processor(s) 718 to determine a compound weight based on the current learning phase and one or more previous learning phases. This is an optional operation. In an optional example, the information from a previous learning phase may be applied in the current learning phase to determine the compound weight.

Instructions 712 cause processor(s) 718 to use the weight (or compound weight) to calculate the number of compression engines and the number of decompression engines for the learning phase.

Instructions 714 cause processor(s) 718 to assign specific hardware accelerator engines as compression engines or decompression engines based on the determination. Execution of compression and decompression jobs is performed using the allocated accelerator engines for the current learning phase. Example job management for compression jobs is provided in FIG. 4 and FIG. 8. Example job management for decompression jobs is provided in FIG. 5 and FIG. 9.

In an example, at the end of the current learning phase the process can be repeated. If not using compound weight calculations, the calculations from the current learning phase are reset for the subsequent learning phase.

FIG. 8 is a block diagram of an example system to dynamically distribute compression and decompression job requests to hardware accelerators. In an example, system 810 can include processor(s) 812 and non-transitory computer readable storage medium 814. In an example, processor(s) 812 and non-transitory computer readable storage medium 814 can be part of a management node having a storage operating system that can provide some or all of the functionality of the ONTAP software as mentioned above.

Non-transitory computer readable storage medium 814 may store instructions 802, 804, 806 and 808 that, when executed by processor(s) 812, cause processor(s) 812 to perform various functions. Examples of processor(s) 812 may include a microcontroller, a microcontroller, a microprocessor, a CPU, a GPU, a DPU, an ASIC, a FPGA, a SoC, etc. Examples of non-transitory computer readable storage medium 814 include tangible media such as RAM, ROM, EEPROM, flash memory, a hard disk drive, etc.

Instructions 802 cause processor(s) 812 to detect the beginning of a learning phase and/or an indication of allocations of hardware accelerator engines to at least a compression pool and a decompression pool for use in handling compression jobs and decompression jobs, respectively. The data sent in the incoming requests may have varying compressibility, as they can have a mix of compressible and incompressible data. Hence, these requests need to be distributed across the number of engines allocated for handling the compression requests as discussed above.

Instructions 804 cause processor(s) 812 to calculate an entropy estimate for one or more incoming compression jobs. In an example, s compressibility score is assigned based on an entropy estimate that is calculated according to the compressibility of the data. An example entropy estimation technique is “Chi Square;” however, other techniques can also be used. A lower data entropy value is indicative of higher compressibility and lower compression cost. Whereas a higher data entropy value indicates lower compressibility and higher compression cost. In an example, the entropy values are be scaled on a range of 1 to 10 and assigned as the compressibility score of the incoming compression request. Other scaling and scoring strategies can also be used, for example, to achieve finer granularity.

Instructions 806 cause processor(s) 812 to assign compression jobs to compression engines in the compression pool based on the calculated compressibility score and the current workload of the compression engine. In an example, each of the compression engines has a tracking mechanism that indicates the current load on it. In an example, the current load of an engine is the sum of compressibility scores of all the compression requests that are enqueued and being processed by that engine. For an incoming compression request, an engine is assigned by analyzing the current loads on all the engines and selecting the engine with the lowest load.

Instructions 808 cause processor(s) 812 to determine if the learning phase is over. The evaluation and assignment processes continue as described until the current learning phase is over. For the subsequent learning phase, a similar set of operations are performed with the updated number of allocated compression engines.

FIG. 9 is a block diagram of an example system to dynamically distribute compression and decompression job requests to hardware accelerators. In an example, system 910 can include processor(s) 912 and non-transitory computer readable storage medium 914. In an example, processor(s) 912 and non-transitory computer readable storage medium 914 can be part of a management node having a storage operating system that can provide some or all of the functionality of the ONTAP software as mentioned above.

Non-transitory computer readable storage medium 914 may store instructions 902, 904, 906 and 908 that, when executed by processor(s) 912, cause processor(s) 912 to perform various functions. Examples of processor(s) 912 may include a microcontroller, a microcontroller, a microprocessor, a CPU, a GPU, a DPU, an ASIC, a FPGA, a SoC, etc. Examples of non-transitory computer readable storage medium 914 include tangible media such as RAM, ROM, EEPROM, flash memory, a hard disk drive, etc.

Instructions 902 cause processor(s) 912 to detect the beginning of a learning phase and/or an indication of allocations of hardware accelerator engines to at least a compression pool and a decompression pool for use in handling compression jobs and decompression jobs, respectively. The management an allocation of decompression jobs is handled differently than the management an allocation of compression jobs because, for compression jobs, a compressibility analysis (e.g., entropy calculation) is used to estimate how compressible the job is and the corresponding cost in terms of hardware accelerator resources. However, for decompression the data has already been compressed and the original entropy calculation information is not available.

Instructions 904 cause processor(s) 912 to calculate a decompression weight for each incoming decompression job. In an example, the input length, which represents the compressed data length, of the decompression request is used to compute a decompression weight for each incoming decompression request. The compressed data may have varying times for various compressed data and normally follow a concave down graph structure (decompression times for 1 blk → 8 blk and 7 blk → 8blk are mostly in the same range, as is for 2 blk → 8 blk and 6 blk → 8 blk and so on). In an example a range of 1 to 4 is used for the decompression weight. Other scales (e.g., 1 to 2, 1 to 8) can be used to provide different granularity.

Instructions 906 cause processor(s) 912 to assign decompression jobs to decompression engines in the decompression pool based on the decompression weight and the current workload of the engine. In an example, each of the decompression engines has a tracking mechanism that indicates the current load on it. In an example, the current load of an engine is the sum of weights of all the decompression requests that are enqueued and still being processed by that engine. For an incoming decompression request, an engine is assigned by evaluating the current loads on all the engines and picking an selecting with the lowest current load.

Instructions 908 cause processor(s) 912 to determine if the learning phase is over. The evaluation and assignment processes continue as described until the current learning phase is over. For the subsequent learning phase, a similar set of operations are performed with the updated number of allocated decompression engines.

FIG. 10 illustrates one embodiment of a block diagram of a node. The nodes illustrated in FIG. 10 can be managed utilizing the compression and decompression job management strategies described herein.

In the example of FIG. 10, node 1000 includes processor 1004 and processor 1008, memory 1010, network adapter 1014, hardware accelerator(s) 1018 (which are analogous to hardware accelerator(s) 124 in FIG. 1) cluster access adapter 1022, storage adapter 1026 and local storage 1020 interconnected by system bus 1002. In an example, processor 1004 can include accelerator management agent 1006, which provides the functionality described above with respect to at least accelerator management agent 104 in FIG. 1. In an example, local storage 1020 can be one or more storage devices, such as disks, utilized by the node to locally store configuration information. In an example, one or more hardware accelerators may reside outside of 1000, but may be accessible by node 1000 to be part of a hardware accelerator pool that can be managed as described herein.

Cluster access adapter 1022 provides a plurality of ports adapted to couple node 1000 to other nodes (not illustrated in FIG. 10) of a cluster. In an example, Ethernet is used as the clustering protocol and interconnect media, although it will be apparent to those skilled in the art that other types of protocols and interconnects may be utilized within the cluster architecture described herein.

In the example of FIG. 10, node 1000 is illustratively embodied as a dual processor storage system executing storage operating system 1012 that can implement a high-level module, such as a file system, to logically organize the information as a hierarchical structure of named directories, files and special types of files called virtual disks (hereinafter generally “blocks”) on the disks. However, it will be apparent to those of ordinary skill in the art that node 1000 may alternatively comprise a single or more than two processor system. In an example, processor 1004 executes the functions of the network element on the node, while processor 1008 executes the functions of the disk element.

In an example, memory 1010 illustratively comprises storage locations that are addressable by the processors and adapters for storing software program code and data structures associated with the subject matter of the disclosure. The processor and adapters may, in turn, comprise processing elements and/or logic circuitry configured to execute the software code and manipulate the data structures. Storage operating system 1012, portions of which is typically resident in memory and executed by the processing elements, functionally organizes node 1000 by, inter alia, invoking storage operations in support of the storage service implemented by the node. It will be apparent to those skilled in the art that other processing and memory means, including various computer readable media, may be used for storing and executing program instructions pertaining to the disclosure described herein.

Illustratively, storage operating system 1012 can be the Data ONTAP® operating system available from NetApp™, Inc., Sunnyvale, Calif. that implements a Write Anywhere File Layout (WAFL®) file system. However, it is expressly contemplated that any appropriate storage operating system may be enhanced for use in accordance with the inventive principles described herein. As such, where the term “WAFL” is employed, it should be taken broadly to refer to any storage operating system that is otherwise adaptable to the teachings of this disclosure. In an example, the ONTAP operating system can provide (or control the functionality of) the rebalancing engine and/or the rebalancing scanner as described herein.

In an example, network adapter 1014 provides a plurality of ports adapted to couple node 1000 to one or more clients over one or more connections 1016, which can be point-to-point links, wide area networks, virtual private networks implemented over a public network (Internet) or a shared local area network. Network adapter 1014 thus may include the mechanical, electrical and signaling circuitry needed to connect the node to the network. Illustratively, the computer network may be embodied as an Ethernet network or a Fibre Channel (FC) network. Each client may communicate with the node over network connections by exchanging discrete frames or packets of data according to pre-defined protocols, such as TCP/IP.

In an example, to facilitate access to disks, storage operating system 1012 implements a write-anywhere file system that cooperates with one or more virtualization modules to “virtualize” the storage space provided by the disks. The file system logically organizes the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization module(s) allow the file system to further logically organize information as a hierarchical structure of blocks on the disks that are exported as named logical unit numbers (LUNs).

In an example, storage of information on each array is implemented as one or more storage “volumes” that comprise a collection of physical storage disks cooperating to define an overall logical arrangement of volume block number (vbn) space on the volume(s). Each logical volume is generally, although not necessarily, associated with its own file system. The disks within a logical volume/file system are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

Storage adapter 1026 cooperates with storage operating system 1012 to access information requested by the clients. The information may be stored on any type of attached array of writable storage device media such as video tape, optical, DVD, magnetic tape, bubble memory, electronic random-access memory, micro-electromechanical and any other similar media adapted to store information, including data and parity information. However, as illustratively described herein, the information is stored on disks or an array of disks utilizing one or more connections 1024. Storage adapter 1026 provides a plurality of ports having input/output (I/O) interface circuitry that couples to the disks over an I/O interconnect arrangement, such as a conventional high-performance, CF link topology.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term "logic" may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Reference in the specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment.

It is contemplated that any number and type of components may be added to and/or removed to facilitate various embodiments including adding, removing, and/or enhancing certain features. For brevity, clarity, and ease of understanding, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

The terms “component”, “module”, “system,” and the like as used herein are intended to refer to a computer-related entity, either software-executing general-purpose processor, hardware, firmware and a combination thereof. For example, a component may be, but is not limited to being, a process running on a processor, a processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can execute from various non-transitory, computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, on non-transitory, computer readable media including, but not limited to, an ASIC (application specific integrated circuit), CD (compact disc), DVD (digital video disk), ROM (read only memory), floppy disk, hard disk, EEPROM (electrically erasable programmable read only memory), memory stick or any other storage device type, in accordance with the claimed subject matter.

What is claimed is:

1. A method comprising:
evaluating a set of requests to determine a number of compression jobs corresponding to the set of requests and a number of decompression jobs corresponding to the set of requests;
allocating a first set of hardware accelerator engines to perform compression jobs and a second set of hardware accelerator engines to perform decompression jobs, wherein the allocation is based on the evaluation of the set of requests;
assigning compression jobs to the first set of hardware accelerator engines based, at least in part, on a compressibility score of the corresponding job and a workload of the selected hardware accelerator engine; and
assigning decompression jobs to the second set of hardware accelerator engines based, at least in part, on a decompression weight of the corresponding job and a workload of the selected hardware accelerator engine.

2. The method of claim 1 further comprising:
evaluating a subsequent set of requests to determine a number of compression jobs corresponding to the subsequent set of requests and a number of decompression jobs corresponding to the set of requests; and
reallocating a first set of hardware accelerator engines and the second set of hardware accelerator engines to a third set of hardware accelerator engines to perform compression jobs and a fourth set of hardware accelerator engines to perform decompression jobs, wherein the allocation is based on the evaluation of the set of requests.

3. The method of claim 1, wherein allocating a first set of hardware accelerator engines to perform compression jobs and a second set of hardware accelerator engines to perform decompression jobs, wherein the allocation is based on the evaluation of the set of requests is based on a compression time for respective compression jobs and a decompression time for respective decompression jobs.

4. The method of claim 3, wherein the compression time is based on an entropy calculation for the respective compression jobs and the decompression time is based on a data length value for the respective decompression jobs.

5. The method of claim 2, wherein the allocating of the first set of hardware accelerator engines and the second set of hardware accelerator engines is valid for a first pre-selected period of time and the reallocating to the third set of hardware accelerator engines and fourth set of hardware accelerator engines is valid for a second pre-selected period of time.

6. The method of claim 1, wherein the compressibility score is based on an entropy calculation for corresponding compression jobs.

7. The method of claim 1, wherein the decompression score is based on an input data length for the corresponding decompression job.

8. A non-transitory computer-readable medium having stored thereon instructions that, when executed by one or more processors, are configurable to cause the one or more processors to:
evaluate a set of requests to determine a number of compression jobs corresponding to the set of requests and a number of decompression jobs corresponding to the set of requests;
allocate a first set of hardware accelerator engines to perform compression jobs and a second set of hardware accelerator engines to perform decompression jobs, wherein the allocation is based on the evaluation of the set of requests;
assign compression jobs to the first set of hardware accelerator engines based, at least in part, on a compressibility score of the corresponding job and a workload of the selected hardware accelerator engine; and
assign decompression jobs to the second set of hardware accelerator engines based, at least in part, on a decompression weight of the corresponding job and a workload of the selected hardware accelerator engine.

9. The non-transitory computer-readable medium of claim 8 further comprising instructions that, when executed by the one or more processors, are configurable to cause the one or more processors to:
evaluate a subsequent set of requests to determine a number of compression jobs corresponding to the subsequent set of requests and a number of decompression jobs corresponding to the set of requests; and
reallocate a first set of hardware accelerator engines and the second set of hardware accelerator engines to a third set of hardware accelerator engines to perform compression jobs and a fourth set of hardware accelerator engines to perform decompression jobs, wherein the allocation is based on the evaluation of the set of requests.

10. The non-transitory computer-readable medium of claim 8, wherein allocating a first set of hardware accelerator engines to perform compression jobs and a second set of hardware accelerator engines to perform decompression jobs, wherein the allocation is based on the evaluation of the set of requests is based on a compression time for respective compression jobs and a decompression time for respective decompression jobs.

11. The non-transitory computer-readable medium of claim 10, wherein the compression time is based on an entropy calculation for the respective compression jobs and the decompression time is based on a data length value for the respective decompression jobs.

12. The non-transitory computer-readable medium of claim 9, wherein the allocating of the first set of hardware accelerator engines and the second set of hardware accelerator engines is valid for a first pre-selected period of time and the reallocating to the third set of hardware accelerator engines and fourth set of hardware accelerator engines is valid for a second pre-selected period of time.

13. The non-transitory computer-readable medium of claim 9, wherein the compressibility score is based on an entropy calculation for corresponding compression jobs.

14. The non-transitory computer-readable medium of claim 9, wherein the decompression score is based on an input data length for the corresponding decompression job.

15. A system comprising:
a memory subsystem having a plurality of interconnected memory devices;
one or more hardware processors coupled with the memory subsystem, the one or more hardware processors configured to:
evaluate a set of requests to determine a number of compression jobs corresponding to the set of requests and a number of decompression jobs corresponding to the set of requests;
allocate a first set of hardware accelerator engines to perform compression jobs and a second set of hardware accelerator engines to perform decompression jobs, wherein the allocation is based on the evaluation of the set of requests;
assign compression jobs to the first set of hardware accelerator engines based, at least in part, on a compressibility score of the corresponding job and a workload of the selected hardware accelerator engine; and
assign decompression jobs to the second set of hardware accelerator engines based, at least in part, on a decompression weight of the corresponding job and a workload of the selected hardware accelerator engine.

16. The system of claim 15, where the one or more hardware processors are further configured to:
evaluate a subsequent set of requests to determine a number of compression jobs corresponding to the subsequent set of requests and a number of decompression jobs corresponding to the set of requests; and
reallocate a first set of hardware accelerator engines and the second set of hardware accelerator engines to a third set of hardware accelerator engines to perform compression jobs and a fourth set of hardware accelerator engines to perform decompression jobs, wherein the allocation is based on the evaluation of the set of requests.

17. The system of claim 15, wherein allocating a first set of hardware accelerator engines to perform compression jobs and a second set of hardware accelerator engines to perform decompression jobs, wherein the allocation is based on the evaluation of the set of requests is based on a compression time for respective compression jobs and a decompression time for respective decompression jobs.

18. The system of claim 17, wherein the compression time is based on an entropy calculation for the respective compression jobs and the decompression time is based on a data length value for the respective decompression jobs.

19. The system of claim 16, wherein the allocating of the first set of hardware accelerator engines and the second set of hardware accelerator engines is valid for a first pre-selected period of time and the reallocating to the third set of hardware accelerator engines and fourth set of hardware accelerator engines is valid for a second pre-selected period of time.

20. The system of claim 16, wherein the compressibility score is based on an entropy calculation for corresponding compression jobs.

21. The system of claim 16, wherein the decompression score is based on an input data length for the corresponding decompression job.
